(19) United States
(12) Patent Application Publication
(10) Pub. No.: US 2009/0023324 A1
(43) Pub. Date: Jan. 22, 2009

(54) LOCKING STRUCTURE OF FLEXIBLE BOARD

(75) Inventors: Masakazu Koike, Tokyo (JP); Masato Takai, Tokyo (JP); Ken Minagawa, Tokyo (JP); Shigeru Mitsuzuka, Tokyo (JP)

Correspondence Address: MCCORMICK, PAULDING & HUBER LLP, CITY PLACE II, 185 ASYLUM STREET, HARTFORD, CT, 06103, US

(73) Assignee: TAIKO DENKI CO., LTD., Tokyo (JP)

(21) Appl. No.: 11/911,350

(22) PCT Filed: Apr. 13, 2006
(86) PCT No.: PCT/JP2006/307854

§ 371 Date: Oct. 12, 2007

(30) Foreign Application Priority Data
Apr. 14, 2005 (JP) 2005-116644
Apr. 22, 2005 (JP) 2005-124948
Nov. 18, 2005 (JP) 2005-334091
Mar. 2, 2006 (JP) 2006-056219

(51) Int. Cl. H01R 13/62; H01R 12/24

(52) U.S. Cl. 439/345; 439/492

(57) ABSTRACT

The object of the present invention is to provide a locking structure of a flexible board, which combines a reliable locking of and a smooth removal of the flexible board inserted to the Non-ZIF type connector, does not widen the width of the flexible board, and thereby does not increase the occupied mounting area of the connector, and furthermore does not compromise one-action insertion and removal. The locking structure 11 of a flexible board for inserting in and removing from a Non-ZIF type connector, comprises a flexible board structure 3 formed from a reinforcing plate laminated on one side surface of the tip end of the flexible board 2, an engaged portion 6 provided on the reinforcing plate of the flexible board structure 3, and an engaging portion 5 provided in a board insertion slot 43 of the connector 4, and wherein when the tip end 3a of the flexible board structure 3 is inserted in the board insertion slot 43, the flexible board structure bends, so the engaged portion 6 engages with the engaging portion 5.

### CROSS REFERENCE TO RELATED APPLICATIONS

This application is entitled to the benefit of and incorporates by reference essential subject matter disclosed in International Patent Application No. PCT/JP2006/307854 filed on Apr. 13, 2006 and Japanese Patent Application No. 2005-116644 filed Apr. 14, 2005; Japanese Patent Application No. 2005-124948 filed Apr. 22, 2005; Japanese Patent Application No. 2005-334091 filed Nov. 18, 2005; and Japanese Patent Application No. 2006-056219 filed Mar. 2, 2006.

### TECHNICAL FIELD

The present invention relates to a locking structure for when a so-called flexible board, such as an FPC (Flexible Print Circuit), an FFC (Flexible Flat Cable) or the like, is inserted into a Non-ZIF type connector.

### BACKGROUND

ZIF type connectors and Non-ZIF type connectors are widely used as means for connecting a flexible board to a circuit board.

A ZIF type connector is formed from a structure in which after a flexible board or a flexible board with a reinforcing plate is inserted into an insertion portion of a connector main body mounted on a circuit board, a turning member and a sliding member provided in the connector main body are operated, and the flexible board is held down to a terminal implanted on the connector main body. So ZIF type connector has excellent insertion workability as the insertion force for when inserting the flexible board in the above described insertion portion can be set to substantially zero.

However, in a ZIF type connector, as it is necessary to operate the turning member and sliding member in order to press the inserted flexible board into the terminal, in addition to the operation space for this operation on the circuit board becoming necessary, the structure inevitably becomes complex, and so becomes high cost. Furthermore, to attach the flexible board in the connector, at least two actions are required, such as inserting the flexible board in the above described insertion portion, and then operating the turning member and sliding member.

On the other hand, a Non-ZIF type connector is structured in which a flexible board or a flexible board with a reinforcing plate is pushed into an insertion portion of a connector main body against elastic force of a terminal implanted in the connector main body. And on top of this structure being simple and low cost, the Non-ZIF type connector is characterized in its excellent operating efficiency, as the flexible board can be attached to the connector in one action, and its operation space on the circuit board being essentially unnecessary.

However, in a Non-ZIF type connector, as the structure is such that the inserted flexible board is held only by the elastic force of the terminal, there is a drawback in that the flexible board easily slips out [of the connector], and, as a countermeasure against this, the providing of a locking mechanism is essential.

An invention disclosed in Japan Patent Office published Unexamined Patent Publication No. H11-191326 is well known as an invention relating to locking of this flexible board. This is an invention in which, as well as attaching a reinforcing plate to the tip end of the flexible board, incisions are made in both side ends thereof to form outwardly bent protruding parts, and thus when this flexible board is inserted into the connector, the above described protruding parts elastically deform inside the connector and exhibit the function of locking.

According to this invention, while an effect of locking the flexible board is obtained, when pulling out this flexible board, there is no way other than to forcefully pull, causing damage to the protruding portions such that they may not be reused (reinserted), and furthermore by forming the protruding portions on the reinforcing plate, the width thereof becomes wider, and accordingly, the connector must also inevitably be widened, and this results in [the invention] having a drawback such as the increase in the occupied mounting area of the circuit board of the connector.

Also, in Japan Patent Office published Unexamined Patent Publication No. H11-329621, an invention in which a flexible board is wound around an auxiliary member and fit into a connector is presented. In this invention, a latch arm comprising a hook is prepared on both side ends of the above described an auxiliary member, and when fitting, this hook engages with the connector to exhibit a locking function, and when removing, the above described engagement is released by operating a free end of this latch arm, such that [the invention] has an effect of allowing an auxiliary member and a flexible board to be smoothly disconnected from the connector.

However, in the invention disclosed in Japan Patent Office published Unexamined Patent Publication No. H11-329621, an auxiliary member of an extremely complex structure must be prepared, which causes increase in costs, and moreover as the flexible board must be wound around the auxiliary member in advance, one action insertion is not possible.

### DISCLOSURE OF THE INVENTION

Due to these kinds of problems, while having many advantages, users are concerned about the drawbacks such as [a flexible board or such] easily slips out of the Non-ZIF type connector, and tend to be unenthusiastic regarding the use of Non-ZIF type connector.

The object of the present invention is to provide a locking structure of a flexible board for inserting in this connector, which combines a reliable locking of and smooth removal of the flexible board, does not widen the width of the flexible board, and thereby does not increase the occupied mounting area of the connector, and furthermore does not compromise one-action insertion and removal.

In order to achieve the above described object, a locking structure of a flexible board of the present invention for inserting in and removing from a Non-ZIF type connector, comprises a flexible board structure formed from a reinforcing plate laminated on one side surface of the tip end of the above described flexible board by positioning the above described reinforcing plate within the alignment region of the plurality of the electrical conductors composing the above described flexible board, an engaged portion provided on the above described reinforcing plate of the flexible board structure by positioning at the medial of widthwise direction of the alignment region of the above described plurality of electrical conductors, and an engaging portion provided in a board insertion slot of the above described connector, and wherein when the tip end of the above described flexible board structure is inserted in the above described board insertion slot, the flexible board structure bends, so the above described engaged portion engages directly with the above described engaging portion without shutting the above described flexible board in.

The above described reinforcing plate may have a fixed portion firmly fixed to the above described flexible board, and a non-fixed portion not firmly fixed [to the above described flexible board], and the above described engaged portion may be provided on this non-fixed portion.

The above described flexible board structure may be formed by firmly fixing the entire surface of the above described reinforcing plate to the above described flexible board, and the above described engaged portion may be formed from a step between the upper end of this reinforcing plate and the above described flexible board.

The above described reinforcing plate may have a cutout portion connecting the front surface and the back surface thereof, this cutout portion may be blocked by the above described flexible board, and the above described engaged portion may be formed from the above described cutout portion.

The present invention is a locking structure of a flexible board to be insert into a Non-ZIF type connector, in which a locking structure of a flexible board is provided at low cost, which combines a reliable locking of and smooth removal of the flexible board, does not widen the width of the flexible board, and thereby does not increase the occupied mounting area of the connector, and furthermore does not compromise one-action insertion and removal.

### BRIEF DESCRIPTION OF THE DRAWINGS

FIG. 1 is a partially broken perspective view showing a locking structure of a flexible board according to a first embodiment of the present invention.

FIG. 2 is a partially broken perspective view showing the locking structure of the flexible board shown in FIG. 1 as viewed from the opposite side.

FIG. 3 is a partially broken cross-sectional perspective view showing an aspect of when the tip end of a flexible board structure is inserted into a connector, wherein the flexible board is used for the locking structure of the flexible board shown in FIG. 1.

FIG. 4 is a partially broken perspective view showing a reinforcing plate, an engaged portion, and the flexible board which composes the flexible board structure.

FIG. 5 is a cross-sectional view at V-V line of FIG. 4.

FIG. 6 is a partially broken perspective view showing a second embodiment of the locking structure of the flexible board.

FIG. 7 is a partially broken perspective view showing a referential embodiment (not the embodiment of the present invention) of the locking structure of the flexible board.

FIG. 8 is a partially broken perspective view showing another referential embodiment (not the embodiment of the present invention) of the locking structure of the flexible board.

FIG. 9 is a partially broken vertical cross-sectional view showing a third embodiment of the locking structure of the flexible board in which especially the flexible board structure is altered.

FIG. 10 is a partially broken vertical cross-sectional view showing a fourth embodiment of the locking structure of the flexible board in which especially the flexible board structure is altered.

FIG. 11 is a partially broken perspective view showing the locking structure of the flexible board according to a fifth embodiment of the present invention.

FIG. 12 is a partially broken perspective view showing the locking structure of the flexible board according to the fifth embodiment of the present invention as seen from the opposite side.

FIG. 13 is a cross-sectional view in the direction of lines XIII-XIII of FIG. 11.

FIG. 14 is a cross-sectional view in the direction of lines XIV-XIV of FIG. 11.

FIG. 15 is a partially broken perspective view of the flexible board structure used for the locking structure according to the fifth embodiment.

FIG. 16 is a partially broken perspective view showing the locking structure of the flexible board according to a sixth embodiment of the present invention.

FIG. 17 is a partially broken perspective view showing the locking structure of the flexible board according to the sixth embodiment of the present invention as seen from the opposite side.

FIG. 18 is a cross-sectional view in the direction of lines XVIII-XVIII of FIG. 16.

FIG. 19 is a cross-sectional view in the direction of lines XIX-XIX of FIG. 16.

FIG. 20 is a partially broken perspective view of the flexible board structure used for the locking structure according to the sixth embodiment.

FIG. 21 is a cross-sectional view in the direction of lines XXI-XXI of FIG. 20.

FIG. 22 is a partially broken perspective view showing the flexible board structure of FIG. 20 as seen from the opposite side.

### DETAILED DESCRIPTION OF THE PREFERRED EMBODIMENTS

The preferred embodiments of the present invention will now be explained.

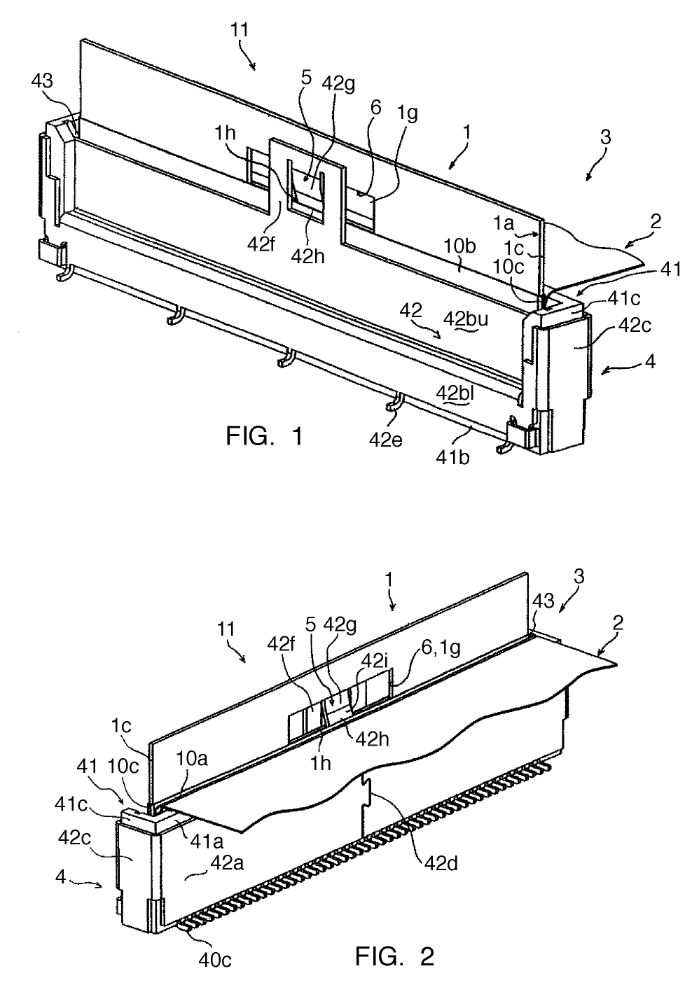

A locking structure of a flexible board according to the first embodiment of the present invention will be explained based on FIG. 1 to FIG. 5.

As FIG. 1 to FIG. 3 show, a locking structure 11 of a flexible board according to the present embodiment is mainly composed from an engaging portion 5 provided on a board insertion slot 43 of a Non-ZIF type connector 4, and an engaged portion 6 provided on a reinforcing plate 1 of the flexible board structure 3 which is inserted in and removed from the connector 4.

The connector 4 is composed of a housing 41 made of an insulating material such as PPS (polyphenylene sulfide) or the like, a plurality of terminals 40 implanted in the inside of the housing 41 spaced apart in the longitudinal direction, and a shell 42 made of steel, aluminum, copper or other such conductive metals and attached to the outside of the housing 41.

The housing 41 is mainly formed and sectioned by a tall rear wall portion 41a, a short front wall portion 41b, and a side wall portion 41c for connecting the rear wall portion 41a and the front wall portion 41b. The terminal 40 has a press-fit portion 40b press fit into a press fitting groove 41d formed in between the rear wall portion 41a and the front wall portion 41b, a contact portion 40a elastically contacted with an electrical conductor 2f of the flexible board 2, and a tail portion 40c soldered to a circuit board not shown in the drawing.

The shell 42 has a rear wall shell 42a stuck to the outside of the rear wall portion 41a which sections and forms the housing 41, a front wall shell 42b stuck to the outside of the front wall portion 41b of the housing 41, and a side wall shell 42c connecting the rear wall shell 42a and the front wall shell 42b stuck to the side wall portion 41c of the housing 41. The rear wall shell 42a, the front wall shell 42b and the side wall shell 42c composing the shell 42 are formed by stamping a metal plate, are connected by a locking hook 42d shown in FIG. 2, and are mounted and earthed in the circuit board via foots 42e provided on the front wall shell 42b.

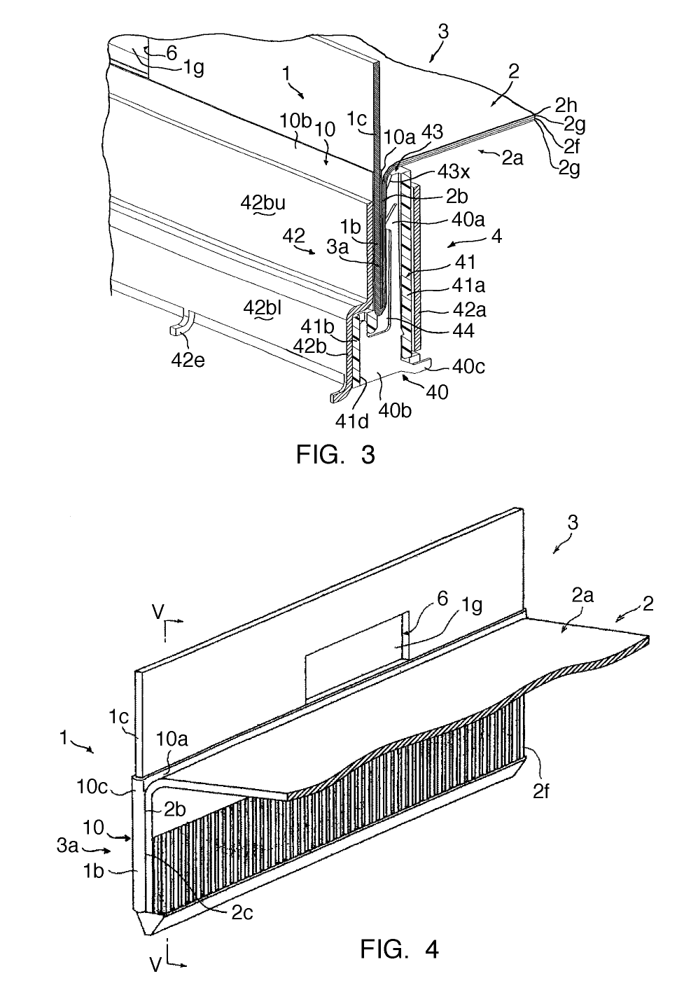

As shown in FIG. 1 and FIG. 3, the front wall shell 42b of the shell 42 is formed from a lower front wall shell 42bl, and an upper front wall shell 42bu, wherein the lower front wall shell 42bl is formed in the lower portion of the front wall shell 42b covering the front wall portion 41b of the housing 41, and the upper front wall shell 42bu is formed by bending substantially perpendicular to a side of the rear wall 41a of the housing 41 from the upper end of this lower portion front wall shell 42bl, and bending again substantially perpendicular at a predetermined distance from the contact portion 40a, and extending upwards to a height substantially identical to that of the upper end of the rear wall shell 42a. As a result, a board insertion space 44 is sectioned and formed between the upper front wall shell 42bu and the rear wall portion 41a.

As FIG. 1 and FIG. 2 show, in the upper front wall shell 42bu of the shell 42, a plate portion 42f is formed extending upward, and on the plate portion 42f, a nail portion 42g is cut and raised to be formed as the engaging portion 5. The nail portion 42g serving as the engaging portion 5, to be described later on, is configured so as to engage with a window portion 1g provided as the engaged portion 6 on the reinforcing plate 1 of the flexible board structure 3, when the tip end 3a of the flexible board structure 3 is inserted into the connector 4.

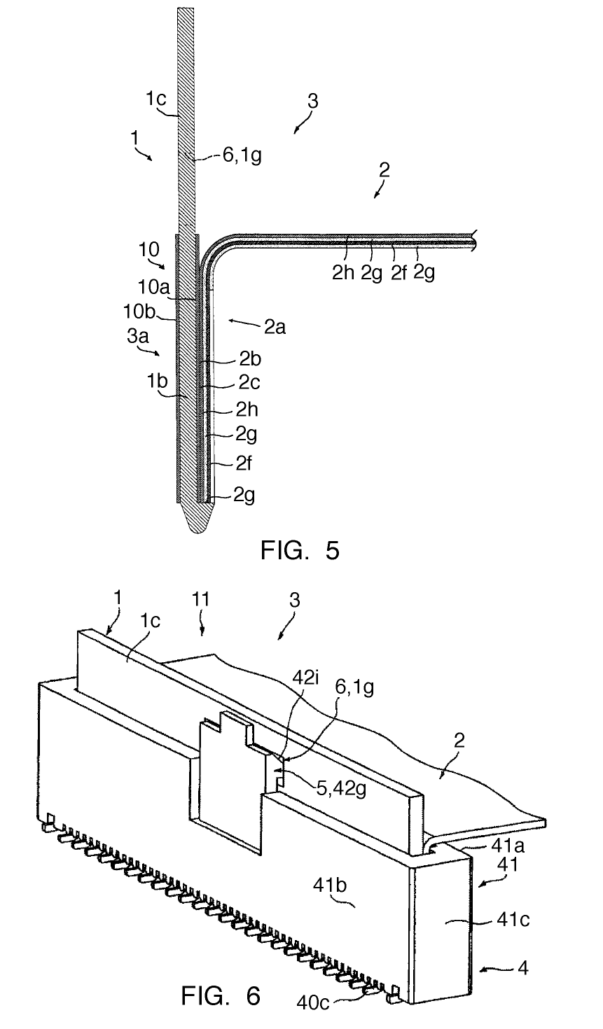

As FIG. 4 and FIG. 5 show, the flexible board structure 3 is mainly configured from the flexible board 2, and the reinforcing plate 1 laminated onto one side surface 2b of the tip end 2a of the flexible board 2.

The flexible board 2 has a pair of base films 2g, 2g made of an insulating material such as polyesters, a plurality of electrical conductors 2f arranged spaced apart in the widthwise direction and sandwiched in between these [base films 2g, 2g], and a shield 2h made of a conductive metallic film (copper, aluminum or the like) which was coated [on] and covers this [base film 2g] on the surface of the base film 2g of the side in which the reinforcing plate 1 is mounted on. The tip end of the base film 2g on the side not coated by the shield 2h is removed such that the electrical conductor 2f is exposed. This electrical conductor 2f, when inserted in the connector 4, as FIG. 3 shows, elastically contacts the contact portion 40a of the terminal 40 of the connector 4 and forms an electric circuit.

As FIG. 5 shows, on the one side surface 2b (the surface of the side on which the shield 2h was coated) of the tip end 2a of the flexible board 2, the reinforcing plate 1 is mounted by means of an electrically conductive adhesive. The reinforcing plate 1 is composed from a material such as a polyethylene terephthalate providing both appropriate stiffness and flexibility. The reinforcing plate 1 is formed in a tabular shape corresponding to the width of the flexible board 2, and has a fixed portion 1b firmly fixed to a section 2c of the frontward insertion direction of the one side surface 2b of the flexible board 2, and a non-fixed portion 1c not firmly fixed to the flexible board 2. As FIG. 3 shows, the fixed portion 1b is inserted along with the flexible board 2 into the connector 4, and at this time the non-fixed portion 1c is exposed and protrudes outwardly from the insertion slot 43 of the connector 4.

In the non-fixed portion 1c of the reinforcing plate 1, the window portion 1g is opened to serve as the engaged portion 6. As FIG. 3 shows, the tip end 3a of the flexible board structure 3 (the section in which the reinforcing plate 1 and the flexible board 2 are laminated) is configured such that when inserted into an insertion space 44 from the insertion slot 43 of the connector 4, as FIG. 1 and FIG. 2 show, the window portion 1g serving as the engaged portion 6 provided on the flexible board structure 3, engages with the nail portion 42g serving as the engaging portion 5 provided on the connector 4. This engagement is achieved by the non-fixed portion 1c of the reinforcing plate 1 running onto the nail portion 42g and elastically deforming, such that the window portion 1g serving as the engaged portion 6 engages with the nail portion 42g serving as the engaging portion 5. Please note that when the non-fixed portion 1c runs onto the nail portion 42g, the nail portion 42g also slightly elastically deforms. Moreover, after this, by flexing the non-fixed portion 1c of the reinforcing plate 1 in the laminated direction of the flexible board 2, the window portion 1g serving as the engaged portion 6 can be removed from the nail portion 42g serving as the engaging portion 5.

As FIG. 4 and FIG. 5 show, the reinforcing plate 1 has a metallic film 10 coated onto the surface of the fixed portion 1b. This metallic film 10 is made of a conductive material such as copper, aluminum or the like, and is configured from a front metallic film 10a formed on the front surface of the fixed portion 1b (the surface of the side on which the flexible board 2 is adhered), a rear metallic film 10b formed on the rear surface of the fixed portion 1b, and a side metallic film 10c connecting both these metallic films 10a, 10b as FIG. 1 and FIG. 2 show. By the front metallic film 10a of the reinforcing plate 1 being adhered and fixed to a section of the shield 2h of the flexible board 2 by means of an electrically conductive adhesive, the shield 2h is conductive with the rear metallic film 10b through the electrically conductive adhesive, the front metallic film 10a and the side metallic film 10c.

The effects of the present embodiment will now be discussed.

As FIG. 3 shows, as the flexible board structure 3 is configured such that the fixed portion 1b of the reinforcing plate 1 being adhered to the one side surface 2b of the tip end 2a of the flexible board 2, as well as the non-fixed portion 1c protruding from and being exposed upward thereof, and so the non-fixed portion 1c is separated from the flexible board 2, and by using this non-fixed portion 1c to function as an operator knob, the tip end 3a can be inserted into and removed from the connector 4, thus increasing workability.

Furthermore, when the tip end 3a of the flexible board structure 3 is inserted into the insertion space 44 from the insertion slot 43 of the connector 4, the electrical conductor 2f of the flexible board 2 runs onto the contact portion 40a of the terminal 40 of the inside of the connector 4, and by means of the contact portion 40a bending, the contact portion 40a elastically contacts the electrical conductor 2f. At this time, the non-fixed portion 1c of the flexible board structure 3 runs onto an inclining portion 42i of the nail portion 42g provided via a plate portion 42f on the upper front wall shell 42bu of the connector 4 shown in FIG. 1 and FIG. 2, and bends, such that the lower end 42h of the nail portion 42g collides with an inner frame lower portion 1h of the window portion 1g provided on the non-fixed portion 1c, and is mechanically engaged. As a result, with one action, a secure locking of the flexible board 2 is achieved, and ease of the insertion operation is ensured. The engagement (lock) is firm as the engaging of the nail portion 42g of the window portion 1g is maintained by restoring force of the non-fixed portion 1c, and cannot be unlocked unless a proactive releasing operation, to be described later on, is performed.

Moreover, when the tip end 3a of the flexible board structure 3 is inserted into the insertion space 44 of the connector 4, as FIG. 3 shows, the shield 2h of the flexible board 2 conducts with the upper front shell wall 42bu configuring the shell 42 of the connector 4, via the metallic film 10 provided on the reinforcing plate 1; and as the shell 42 is earthed to the circuit board via the foots 42e, a high shielding effect is exhibited. In other words, the shield 2h is earthed to the circuit board via the electrically conductive adhesive, the front metallic film 10a, the side metallic film 10c, the rear metallic film 10b, the front wall shell 42b and the foots 42e, so noise flying into the shield 2h can be reliably discharged from the foots 42e to the circuit board. Please note, if the reinforcing plate main body la is a metal having conductive properties, the metallic film 10 can be omitted.

In order to remove the tip end 3a of the flexible board structure 3 from the insertion space 44, it is necessary to grasp the non-fixed portion 1c and press-fit it in the laminating direction of the flexible board 2, so the tip end 3a is pressed against a guiding surface 43x, formed in an inclined plane shape or an R-shape in the insertion opening 43 as shown in FIG. 3, and the flexible board structure 3 is bent at the lower end thereof as a base point. Then the inner frame lower portion 1h (see FIG. 1) of the window portion 1g provided on the non-fixed portion 1c is removed from the lower end 42h of the nail portion 42g of the connector 4, and by pulling [the flexible board structure 3] out, removal can be completed. The guiding surface 43x of the insertion slot 43 is formed widening at the top, and as previously described, does not only function as a pressed surface relative to the bending reinforcing plate 1, but also functions as a guide for when the tip end 3a of the flexible board structure 3 is inserted into the insertion space 44.

In addition, at the time of the above described removal, rather than flexing the non-fixed portion 1c, the nail portion 42g may be forced in leftward in FIG. 2, or these [actions] may both be performed simultaneously. When engaging•releasing the window portion 1g and the nail portion 42g, as the flexibility of the non-fixed portion 1c and/or the elasticity of the nail portion 42g is being used, no stress whatsoever is added to the flexible board structure 3 itself, and thus at the time of removal, the reinforcing plate will not be damaged or be impossible to reuse as in the conventional example disclosed in Japanese Unexamined Patent Publication No. H11-191326.

Moreover, as the flexible board structure 3 can be manufactured by simply laminating and attaching the reinforcing plate 1 to the existing flexible board 2, there is no need to implement improvements to the flexible board 2 itself, thus a locking structure of a flexible board can be applied to prior or existing, or commercially available flexible boards 2, and can be provided at low cost.

Also, for the reinforcing board 1, it is not necessary to be configured as an auxiliary member of a complex structure disclosed in the previously described in Japanese Unexamined Patent Publication No. H11-329621, and as it is in an extremely simple shape of only a flat plate provided with a window portion 1g, and it can be provided at a low cost.

Furthermore, as it is only necessary for the reinforcing plate 1 to be laminated and attached to the existing flexible board 2, there is no need to widen the width of the flexible board 2 as is written in Japanese Unexamined Patent Publication No. H11-191326, and accordingly there is also no increase to the width of the connector 4 and no increase to the occupied mounting area thereof, and as a whole the locking structure including the connector 4 side becomes low cost.

Moreover, as a nail portion 42g serving as the engaging portion 5 is provided in one part of the shell 42 (made of metal) as a countermeasure against noise, there is no need to provide this [nail portion 42g] in the housing 41 (made of resin), and a highly stiff engaging portion 5 can be obtained. However, it is not essential that this shell 42 be provided in the connector 4, and the engaging portion 5 may also be provided in the housing 41.

Furthermore, this locking structure 11 does not whatsoever compromise the above described characteristics of a Non-ZIF type connector 4.

Additionally, in a case in which two Non-ZIF type connectors are mounted in one circuit board, and between these a flexible board is inserted parallel to the circuit board, when removing the flexible board from the connector, the flexible board cannot even be grasped, and so conventionally removal is impossible. However, in the present embodiment, as the non-fixed portion 1c is protruding from the connector 4 as previously described, by using the [non-fixed portion 1c] as an operator knob, the flexible board structure 3 can be easily removed from the connector 4.

Moreover, the locking of the flexible board structure 3 can take place between the window portion 1g serving as the engaged portion 6 provided on the non-fixed portion 1c of the reinforcing plate 1, and the nail portion 42g serving as the engaging portion 5 formed in the shell 42 of the connector 4, and thereby even if the flexible board 2 is pulled in the upper right direction or the rightward horizontal direction in FIG. 1 during the insertion operation or such of the flexible board 2, the engagement of the window portion 1g serving as the engaged portion 6 and the nail portion 42g serving as the engaging portion 5 is not released.

Next, second embodiments of the present invention will be explained using FIG. 6.

A locking structure 11 of a flexible board according to the second embodiment shown in FIG. 6 is a structure in which the nail portion 42g serving as the engaging portion 5 is formed in the housing 41 sectioning and forming the connector 4. Also in this case, by using the non-fixed portion 1c of the reinforcing plate 1 as an operator knob, when the flexible board structure 3 is inserted into the connector 4, the non-fixed portion 1c of the flexible board structure 3 runs onto the inclining portion 42i of the nail portion 42g of the connector 4 and bends, and then the window portion 1g serving as the engaged portion 6 engages with the nail portion 42g. When removing, the window portion 1g can be removed from the nail portion 42g by flexing the non-fixed portion 1c in the laminated direction of the flexible board 2 (in FIG. 6, rightward).

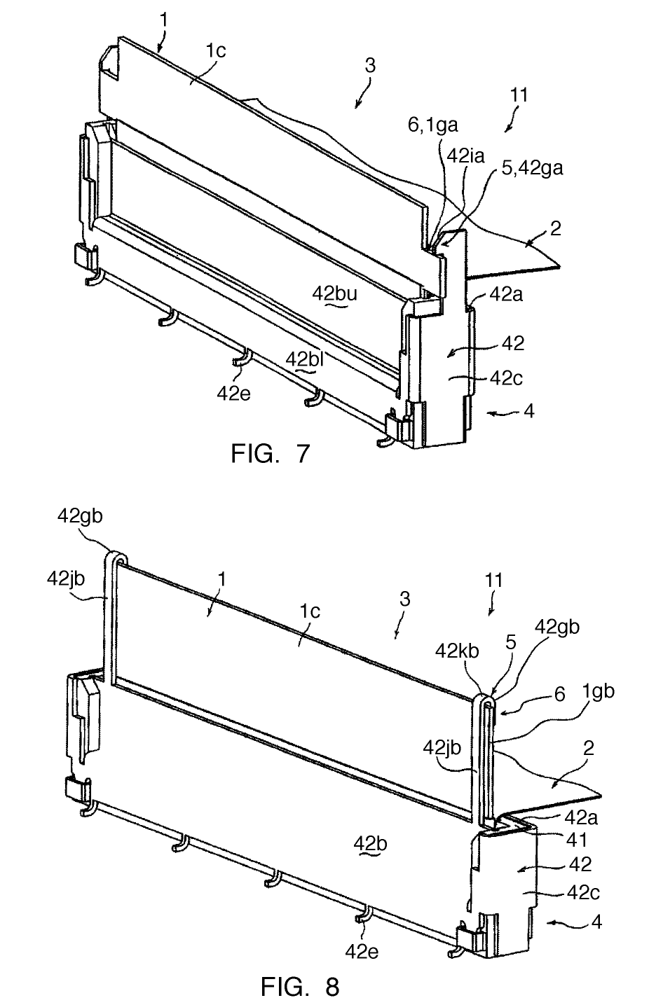

Moreover, the locking structure 11 of the flexible board according to the referential embodiment (not the embodiment of the present invention) shown in FIG. 7, is a structure in which a step portion 1ga formed by cutting out both widthwise end portions of the non-fixed portion 1c of the reinforcing plate 1 serves as the engaged portion 6, and a hook portion 42ga formed in the side wall shell 42c of the connector 4 serves as the engaging portion 5. Even in this case, by using the non-fixed portion 1c of the reinforcing plate 1 as an operator knob, when the flexible board structure 3 is inserted into the connector 4, both end portions of the non-fixed portion 1c run onto an inclining portion 42ia of the hook portion 42ga of the connector 4 and bend, such that the step portion 1ga engages with the hook portion 42ga and locks. When removing, the step portion 1ga can be separated from the hook portion 42ga and can be removed by grasping the non-fixed portion 1c, and by pulling [the non-fixed portion 1c] out while flexing it in the opposite direction of the laminated side of the flexible board 2 (in the drawing leftward). Moreover, in this embodiment, as is clear from FIG. 7, the hook portion 42ga is positioned so as to be oriented facing left in the drawing, in other words so as to be oriented to the laminated surface of the flexible board 2 of the reinforcing plate 1, however it may also be oriented in the opposite direction (facing right in the drawing). In this case, the direction for bending the non-fixed portion 1c is opposite when removing.

The locking structure 11 of the flexible board according to another referential embodiment (not the embodiment of the present invention) shown in FIG. 8, is a structure in which a catch portion 42gb formed in an upside down J-shape at both widthwise end portions of the front wall shell 42b of the connector 4, serves as the engaging portion 5, and a section 1gb opposing the above described catch portion 42gb at both widthwise ends portions of the non-fixed portion 1 c of the reinforcing plate 1, serves as the engaged portion 6. The catch portion 42gb is formed from an extending portion 42jb extending upward from the upper end portion of the front wall shell 42b of the side opposite to the surface on which the reinforcing plate 1 of the flexible board 2 is mounted, and a bending portion 42kb on the tip end of this extending portion 42jb, bended 180 degrees at a predetermined length onto the side on which the flexible board 2 is mounted. As a result, after the flexible board structure 3 is inserted into the connector 4 in the same manner as the embodiments described previously, or together with inserting, by bending the non-fixed portion 1c so as to cause it to buckle such that the central section thereof forms a convex shape to the rightward in the drawing, and/or by elastically deforming the left and right extending portions 42jb, 42jb in V-shape in an outward widthwise, the above described section 1gb of the non-fixed portion 1c is engaged in the inside of the curving portion 42kb of the catch portion 42gb, and can be locked. Also, when removing, by using the non-fixed portion 1c as an operator knob, bending [the non-fixed portion 1c] such that a the central section thereof is formed in a convex shape to the right in the drawing in the same manner as when engaging, and/or by elastically deforming the extending portions 42jb, 42jb in a V-shape, the above described section 1gb of the non-fixed portion 1c is separated from the bended portion 42kb, and the flexible board structure 3 can be removed from the connector 4 by pulling out.

Please note, it goes without saying that the second embodiment shown in FIG. 6 have the same functions and effects as the first embodiment.

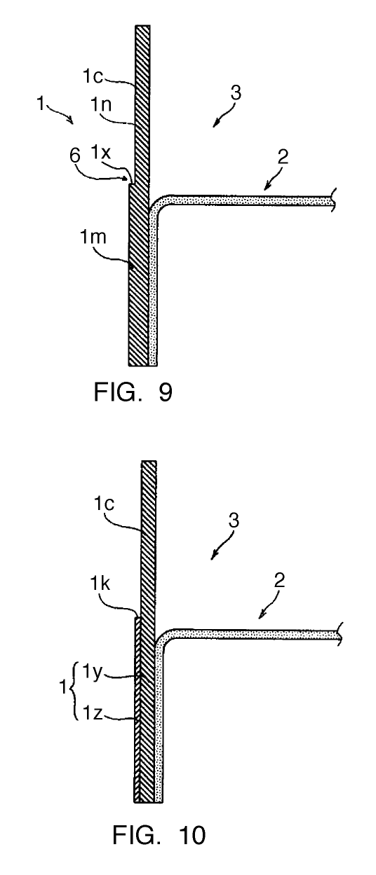

Third and fourth embodiments of the present invention will now be explained using FIG. 9 and FIG. 10.

FIG. 9 is a vertical cross-sectional view of the flexible board structure 3 employed in the locking structure of the flexible board according to the third embodiment. As the drawing shows, this flexible board structure 3 is a structure in which a step portion 1x is provided in the non-fixed portion 1c of the reinforcing plate 1 of the flexible board structure 3 shown in FIG. 4 and FIG. 5, formed protruding in the thickness direction thereof, serves as the engaged portion 6. The step portion 1x is formed in the widthwise direction along a surface of the non-fixed portion 1c opposite to the surface on which the flexible board 2 is mounted. In other words, the reinforcing plate 1 is in a formation in which a thick board portion 1m and a thin board portion 1n are integrally connected in the insertion direction, and the step portion 1x is formed at the connecting portion thereof. The step portion 1x forming the engaged portion 6 engages in the same manner as the first embodiment with the lower end 42h of the nail portion 42g serving as the engaging portion 5 comprised in the connector 4 of the first embodiment shown in FIG. 1 and FIG. 2, or engages in the same manner as the second embodiment with the nail portion 42g serving as the engaging portion 5 comprised in the connector 4 of the second embodiment shown in FIG. 6.

FIG. 10 is a vertical cross-sectional view of the flexible board structure 3 employed in the locking structure of the flexible board according to the fourth embodiment. As the drawing shows, the flexible board structure 3 is a structure in which the reinforcing plate 1 of the flexible board structure 3 shown in FIG. 4 and FIG. 5 is configured by laminating and substantially aligning the lower end surfaces of a first reinforcing plate 1y and a second reinforcing plate 1z of a lower height than [the first reinforcing plate 1y], and in which an upper end 1k of the second reinforcing plate 1z, in other words the rear end surface in the insertion direction, serves as the above described step portion. The second reinforcing plate 1z is mounted on the opposite surface of the first reinforcing plate 1y to the surface on which the flexible board 2 is mounted. The upper end 1k is configured so as to engage, in the same manner as shown in FIG. 9, with the lower end portion 42h of the nail portion 42g of the first embodiment shown in FIG. 1 and FIG. 2, or with the nail portion 42g of the second embodiment shown in FIG. 6.

Please note that the third and fourth embodiments shown in FIG. 9 and FIG. 10 have the same functions and effects as the first embodiment.

Moreover, in FIG. 1 to FIG. 10, the board 2 of the flexible board structure 3 is bended at a substantially right angle adjacent to the edge of the fixed portion 1b and the non-fixed portion 1c of the reinforcing plate 1, however, this is simply to show an image in which another connector or such joined to the other end of the flexible board 2 exists in this direction, and including the bending, has no special meaning whatsoever, and does not prevent [the board 2] from extending substantially perpendicularly.

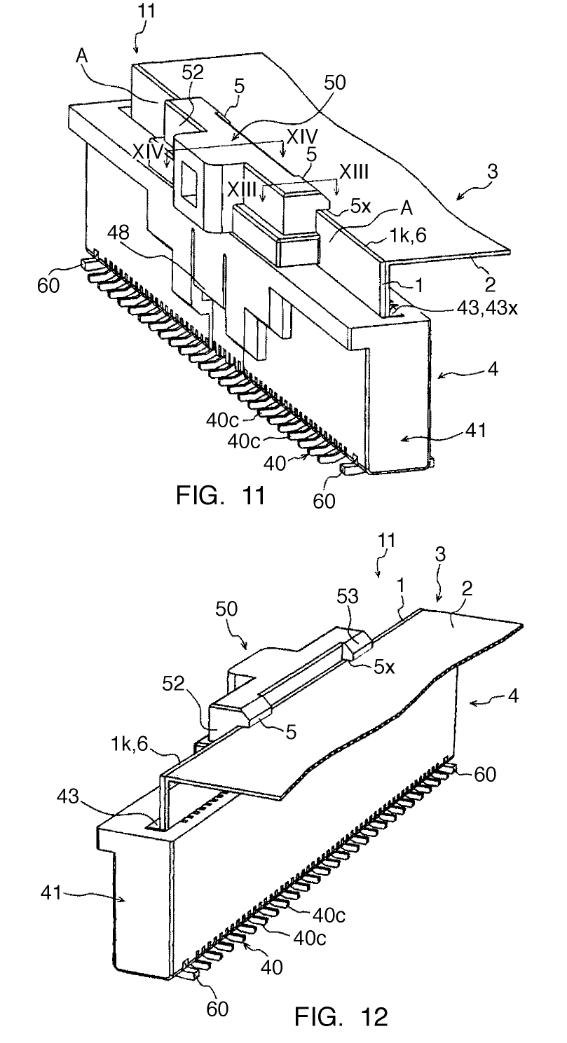

Next, the locking structure of the flexible board according to the fifth embodiment of the present invention will be explained using FIG. 11 to FIG. 15.

In FIG. 11 and FIG. 12, 4 is a Non-ZIF type connector and 3 is a flexible board structure fitted thereinto. The connector 4 has a connector housing 41 made of a synthetic resin such as PPS (polyphenylene sulfide) or the like, a plurality of terminals 40 made of metal of phosphor bronze or such and provided inside the housing 41, and a locking member 50 made of the same quality of materials as the housing 41 and built onto an upper portion of the housing 41. As will be described later, the engaging portion 5 is provided in the locking member 50, the flexible board structure 3 has a reinforcing plate 1, and an upper end 1k of the reinforcing plate 1 functions as the engaged portion 6. Please note, 60 is a mounting bracket mounted on the housing 41 for fixing the housing 41 on a circuit board not shown in the drawing.

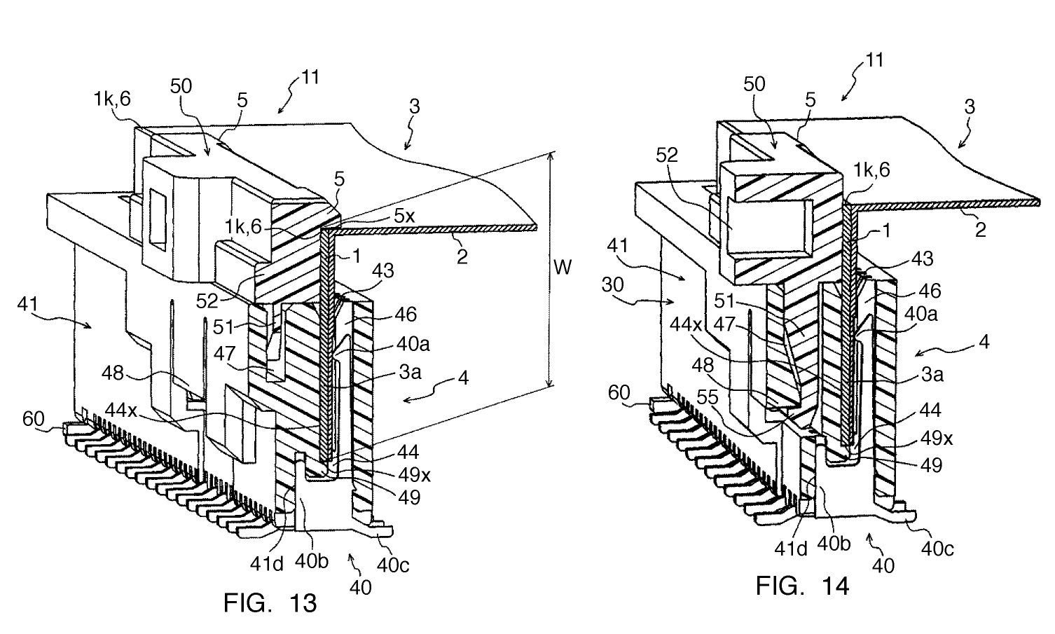

This embodiment will now be explained in more detail using FIG. 13 and FIG. 14. The housing 41, is shown as a substantially rectangular shape, and is comprised of a long and narrow board insertion slot 43 formed on an upper surface for inserting and removing the tip end 3a of the flexible board structure 3, a board insertion space 44 formed internally connected to the board insertion slot 43, a press fit groove 41d into which the terminal 40 is press fit, a terminal groove 46 into which the terminal 40 is inserted•guided, a fitting groove 47 into which a fitting portion 51 of the locking member 50 intrudes, and a butting portion 49 to collide with the tip end 3a of the flexible board structure 3 limiting the insertion depth thereof. In an upper surface of the butting portion 49, a butting surface 49x is formed abutting the lower end of the tip end 3a of the flexible board structure 3.

The terminal 40 has a press fit portion 40b fit in the press fit groove 41d of the housing 41, a contact portion 40a projecting upward from the press fit portion 40b and loosely fitted into the terminal groove 46 of the housing 41, and a tail portion 40c projecting sideways from the press fit portion 40b and mounted on a circuit board, not shown in the drawing.

For your information, relative to the housing 41, the terminals 40 are arranged in a so-called zigzag, such that the tail portions 40c thereof are divided per each into the right side and the left side. On the terminals 40 as shown, there are 25 tail portions 40c in FIG. 11, and also 25 in FIG. 12, making a total of 50 [tail portions 40c] implanted in the housing 41. All of the contact point portions 40a of the terminals 40 are in the inside of the housing 41 (board insertion space 44), and are oriented•arranged in a row all in the same direction. Moreover, the terminals 40 are press fit facing upward from the downward [portion] of the housing 41.

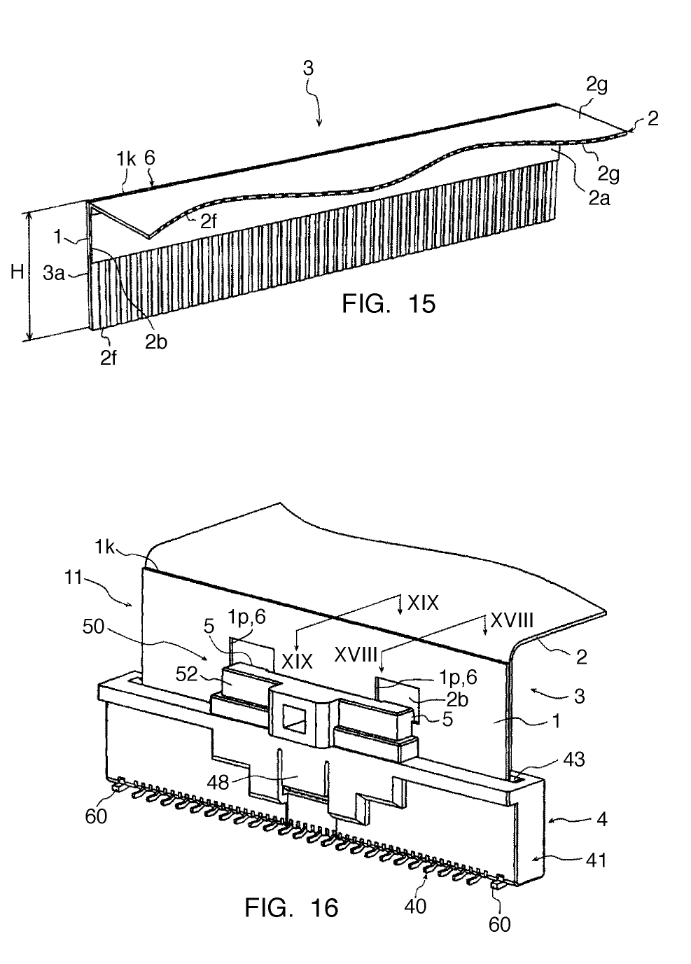

The flexible board structure 3, as shown in FIG. 15, is structured mainly from the flexible board 2, and the reinforcing plate 1 entirely fixed onto one side surface 2b of the tip end 2a of the flexible board 2, and the upper end 1k of the reinforcing plate 1 serves as the engaged portion 6. In other words, the upper end 1k (engaged portion 6) engages with the engaging portion 5 of the locking member 50 attached to the connector 4 when the tip end 3a of the flexible board structure 3 is inserted into the connector 4.

The flexible board 2 has a plurality of electrical conductors 2f made of copper wire or the like and arranged spaced apart in the widthwise direction thereof, and a base film 2g made of an insulating material such as polyester or the like, positioned so as to shut-in the electrical conductor 2f and fill-in between the electrical conductors 2f, and in the tip end of the board 2, the base film 2g is removed from the side on which the reinforcing plate 1 is not attached, and there the electrical conductor 2f is exposed.

The reinforcing plate 1 fixed to the flexible board 2, is made of a material such as polyethylene terephthalate, has flexibility, and is pasted onto the entire surface of the flexible board 2. Moreover, the reinforcing plate 1 as well as the tip end and both side ends of the flexible board 2 are each aligned and are substantially flush.

In this kind of flexible board structure 3, as the stiffness of the tip end 3a is increased by laminating the reinforcing plate 1 on the flexible board 2, when this tip end 3a is inserted into the above described connector 4 (Non-ZIF type), even if insertion resistance is generated due to the bending of the contact portion 40a of the terminal 40, it can be smoothly inserted. Also, in the tip end 3a of the above described board structure 3, as the electrical conductor 2f is exposed, that electrical conductor 2f elastically contacts the contact portion 40a of the terminal 40.

The locking member 50 has, as shown in FIG. 11, FIG. 13 and FIG. 14, a main body 52 placed adjacent to the central portion of the long and narrow board insertion slot 43 and positioned on the upper surface of the housing 41, a fitting portion 51 hanging from the main body 52 and engaged in the fitting groove 47 formed on the upper surface of the housing 41, a hook 55 for engaging with the catch portion 48 formed in the housing 41, and an engaging portion 5 projecting in a direction (sideward) covering the [area] upwards [from] the board insertion slot 43 from the upper portion of the main body 52. The engaging portion 5 is formed as two [engaging portions] spaced apart in the widthwise direction of the board insertion slot 43, and in the lower surface of the engaging portion 5, an engaging surface 5x is formed abutting and engaging with an upper end 1k of the reinforcing plate 1.

The locking member 50, as shown in FIG. 14, is molded separately from the housing 41, and is firmly built on and integrated with the housing 41 by later on the fitting portion 51 being inserted into the fitting groove 4 as well as the hook 55 engaging with the catch portion 48. As a result, as previously described, even in a structure in which the engaging portion 5 protrudes in the [area] upwards [from] the board insertion slot 43, when molding the housing 41, a situation in which the forming die cannot be released does not occur.

In the housing 41 and the locking member 50 integrated in this way, the space W (see FIG. 13) between the abutting surface 49x of the abutting portion 49 of the housing 41 and the engaging surface 5x of the engaging portion 5 of the locking member 50, substantially corresponds to the height H (see FIG. 15) of the reinforcing plate 1. Preferably, the space W is set slightly smaller than the height H, such that when the flexible board structure 3 is inserted into the connector 4, the reinforcing plate 1 slightly is compressed to bend between the abutting surface 49x and the engaging surface 5x so as to elastically deform, and is held [therebetween].

When manufacturing the flexible board structure 3 previously described, in a case in which a commercially available flexible board with a reinforcing plate is used without modification, a connector 4 should be designed so that the space W between the butting surface 49x of the housing 41 and the engaging surface 5x of the locking member 50 is set corresponding to the height H of this reinforcing plate 1. On the other hand, due to reasons such as the limiting of height of the connector, in a case in which the space W between the abutting surface 49x of the housing 41 and the engaging surface 5x of the locking member 50 is set in advance, a reinforcing plate 1 with a height H matching this space W will be adhered to the flexible board 2, a reinforcing plate yet to be laminated.

Effects of the present embodiment will now be explained.

When inserting the flexible board structure 3 into the connector 4, first the flexible board structure 3 is grasped so that the electrical conductor 2f of the flexible board structure 3 faces the terminal contact portion 40a of the connector 4. Next, the tip end 3a of the structure 3 is inserted into the board insertion space 44 from the board insertion slot 43 of the housing 41. At this time, as the engaging portion 5 of the locking member 50 is extended in the [area] upwards [from] the board insertion slot 43, to get around this, the tip end 3a of the flexible board structure 3 is inserted at a slight slant.

At this time, the tip end of the rear surface (surface on which the board 2 is not adhered) of the reinforcing plate 1 slides on the inner wall 44x (FIG. 13, FIG. 14) of the housing 41, and advances into the board insertion space 44 while the electrical conductor 2f abuts the terminal contact portion 40a and elastically deforms the contact portion 40a, so the tip end 3a of the flexible board structure 3 encounters a predetermined amount of insertion resistance. However as stiffness is increased by the reinforcing plate 1, smooth insertion is possible.

When advancing further the tip end 3a of the flexible board structure 3, in addition to the tip end of the rear surface of the reinforcing board 1 contacting the inner wall 44x of the housing 41, the rear surface of the reinforcing plate 1 is formed so as to also abut the tip end of the engaging portion 5, and if insertion force is slightly increased and the tip end 3a is pushed in at this moment, the tip end 3a provided with both the appropriate stiffness and flexibility advances into the board insertion space 44 while bending like a bow. Then, at the moment the tip end of the reinforcing plate 1 abuts the butting surface 49x of the butting portion 49 of the housing 41, the upper end 1k of the reinforcing plate 1 gets under the engaging surface 5x of the engaging portion 5, and the bending which the reinforcing plate 1 required to pass over the engaging portion 5 is virtually eliminated, and [the reinforcing plate 1] is held in between the abutting surface 49x of the housing 41, and the engaging surface 5x of the engaging portion 5 of the locking member 50.

At this same time, the electrical conductor 2f of the tip end 3a is in pressure contact with the terminal contact portion 40a, and an electrical connection between the circuit board in which the terminal 40 is soldered to, and the flexible board 2 is completed. At this time, the contact portion 40a of the terminal 40 bends with the lower portion as the base point, and elastically deforms.

As a result, the tip end 3a of the flexible board structure 3 is held between the engaging portion 5 of the locking member 50 and the butting portion 49 of the housing 41, and moreover is in a state of being pressed onto the inner wall 44x side (the opposite free end side of the engaging portion 5 of the locking member 50) of the housing 41 by means of the restoring force of the elastically deformed contact portion 40a, whereby unless a special external force is acted thereon, it will not slip out of the connector 4. Moreover, as previously described, if the space W between the abutting surface 49x of the housing 41 and the engaging surface 5x of the engaging portion 5 of the locking portion 50 is made slightly smaller than the height H of the reinforcing plate 1, as the reinforcing plate 1 is held in the space W in a state in which it is slightly elastically deformed, it becomes even harder [for the tip end 3a] to slip out.

On the other hand, when intentionally removing the tip end 3a of the flexible board structure 3 from the connector 4, in FIG. 11, by pushing with finger or such in the area of a portion A of the reinforcing plate 1 exposed upward from the board insertion slot 43 and not covered by the locking member 50, to the free end side of the engaging portion 5, the board structure 3 is elastically deformed such that the engagement of the upper end 1k and the engaging portion 5 is released, and after setting free the upper end 1k, by lightly pulling out the tip end 3a upward at a slant, [removal] is completed. In other words, as the locking member 50 and the engaging portion 5, are only adjacent in one portion (central portion in the drawing examples) in the longitudinal direction of the long and narrow board insertion slot 43, in the reinforcing plate 1 protruding from the board insertion g slot 43, a portion (above described portion A) not covered by the locking member 50 and the engaging portion 5 is created, and by pushing this portion A with a finger or the like, the lock can be released.

In the present embodiment, as the board structure 3, similar to the invention disclosed in Japanese Unexamined Patent Publication No. H11-191326, does not require the provision of a [component] such as a protruding portion on the side of the reinforcing plate, there is no widening to the width of the board, or increasing to the total width, in other words the occupied mounting area, of the connector. Moreover, as there is no need to provide a component such as the auxiliary member disclosed in Japanese Unexamined Patent Publication No. H11-329621, a low cost locking structure can be configured.

Furthermore, as the flexible board structure 3 is configured with the upper end 1k of the reinforcing plate 1 as the engaged portion 6 corresponding to the engaging portion 5 of the connector 4, by bending the board 2 at the upper end 1 k to substantially 90 degrees, the height of the tip end 3a when inserted into the connector 4 can be kept low, and as such [the flexible board structure 3] is able to satisfy requirements for miniaturization, slimming and such of electronic equipments.

Please note, this connector 4 is not a ZIF type comprising a moveable member such as a slider, an actuator or such, but as the basic structure [of the connector] is that of an unmodified Non-ZIF type, it goes without saying that board insertion with one action, which is a main feature thereof, is possible.

Moreover, in the present embodiment, in FIG. 11 to FIG. 15, the board 2 of the flexible board structure 3 is caused to flex in a substantially right angle direction in the proximity of the upper end 1k of the reinforcing plate 1, however this is simply [to] show an image in which another connector or such connected to the other end of the flexible board structure 3 exists in this direction, and including the flexing, has no special meaning whatsoever, and does not prevent the [board 2 from] extending substantially perpendicularly while avoiding the engaging portion 5 of the locking member 50.

Furthermore, in the present embodiment, an example was shown in which the abutting portion 49 (FIG. 13, FIG. 14) of the housing 41 was provided in the housing 41, however this function can also be shifted to the terminal 40.

Additionally, the engaging surface 5x of the engaging portion 5 of the locking member 50 may not only be formed horizontally, but [may also be formed] as a slightly downward inclining surface facing the free end side of the engaging portion 5 of the locking member 50, or a component forming a slightly protruding shape in a downward portion of the free end, to achieve improvement of the locking•latching properties of the reinforcing plate 1.

Also, the engaging portion 5 of the locking member 50, is not limited to an [engaging portion] positioned adjacently to the central portion of the longitudinal direction of the long and narrow board insertion slot 43, such as that of the present embodiment shown in FIG. 11, and may be positioned adjacently to both end portions or one end portion of the board insertion slot 43. The point being that the portion (the portion which is pressed to release the lock) of the reinforcing plate 1 not covered by the locking member 50 and the engaging portion 5 can be maintained when the tip end 3a of the flexible board structure 3 is inserted and locked.

Moreover, the latch width (the length from the free end of the engaging portion 5 to the fixed end) of the engaging surface 5x of the locking member 50, may be configured to correspond the thickness of the reinforcing plate 1, and the board 2 may be configured such that it does not forcedly bend by means of the engaging surface 5x of the locking member 50.

Next, the locking structure of the flexible board according to the sixth embodiment of the present invention will be explained using FIG. 16 to FIG. 22.

In FIG. 16 and FIG. 17, 4 is a Non-ZIF type connector, and 3 is a flexible board structure fit therein. The connector 4 has a housing 41 made of a synthetic resin such as PPS (polyphenylene sulfide) or the like, a plurality of terminals 40 made of metal of phosphor bronze or such and provided inside the housing 41, and a locking member 50 formed from the same quality of materials [as the housing 41] and is built onto an upper portion of this housing 41. As will be described later, an engaging portion 5 is provided in the locking member 50, the flexible board structure 3 has a reinforcing plate 1, and a cutout portion 1p functioning as an engaged portion 6 is provided on the reinforcing plate 1.

Please note, as this connector 4 is of a similar configuration to the connector 4 previously described using FIG. 11 to FIG. 14, in FIG. 16 to FIG. 19 and so on, identical parts are given identical reference numbers and explanations thereof are omitted.

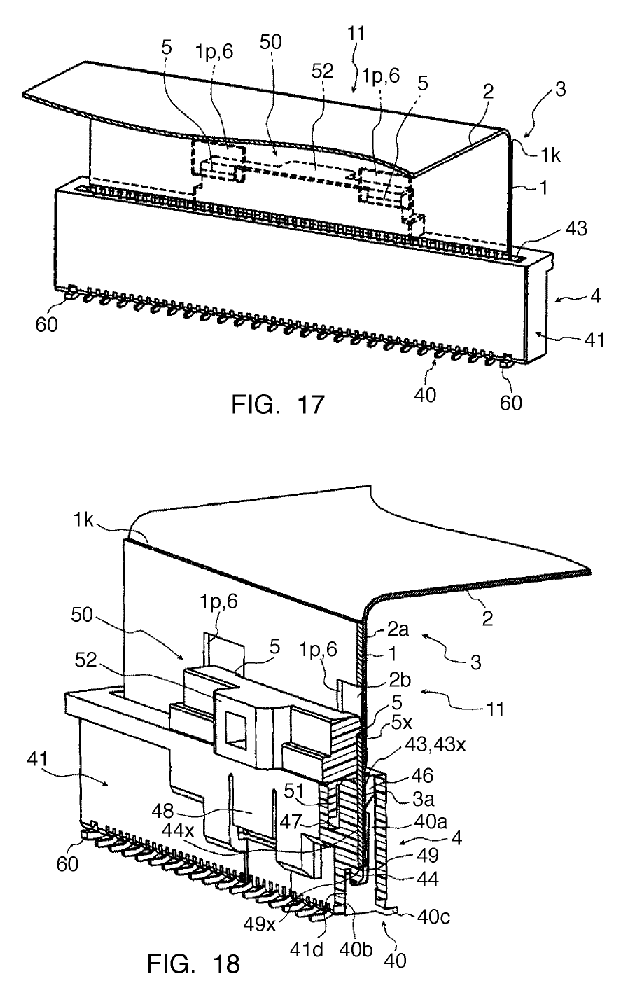

The flexible board structure 3 is, as FIG. 18 to FIG. 22 show, configured mainly from the flexible board 2, the reinforcing plate 1 firmly fixed to one side surface 2b of the tip end 2a of this flexible board 2, and a cutout portion 1p serving as the engaged portion 6 is provided on the reinforcing plate 1. The cutout portion 1p serving as the engaged portion 6 engages with the engaging portion 5 of the connector 4 when the tip end 3a of the flexible board structure 3 is inserted into the connector 4.

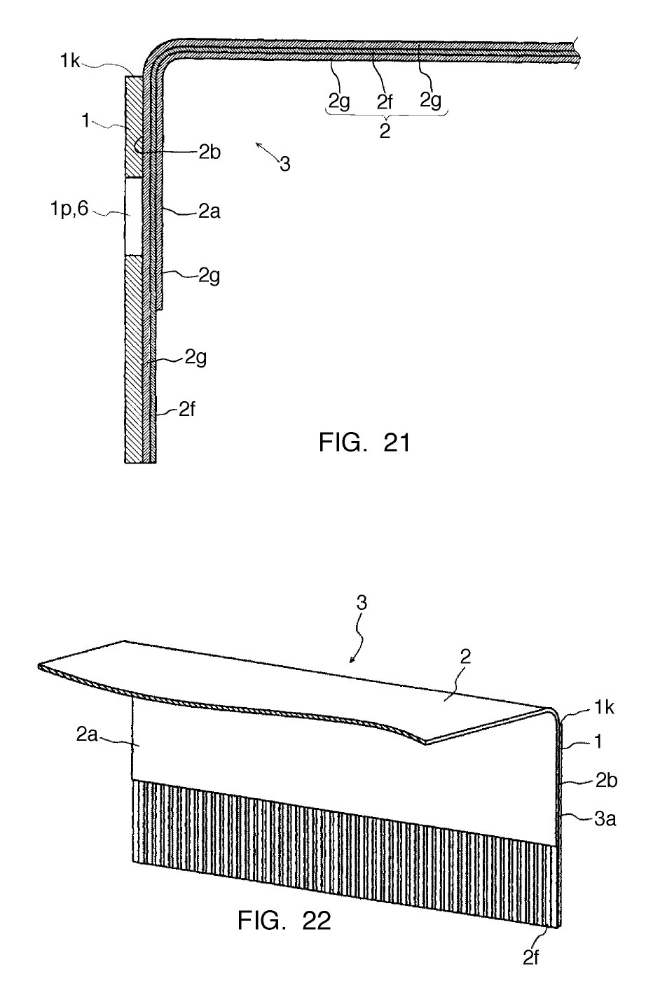

The flexible board 2 is, as FIG. 21 shows, formed from an electrical conductor 2f and a base film 2g. As this flexible board 2 has a configuration similar to that of the flexible board 2 of the embodiment previously described using FIG. 15, identical parts are given identical reference numbers and explanations thereof are omitted.

The reinforcing board 1 firmly fixed to the board 2 is made of materials such as polyethylene terephthalate, has appropriate flexibility and stiffness, and is pasted onto the base film 2g of the side not exposing the above described electrical conductor 2f. Accordingly, the laminated portion (the tip end 3a of the board structure 3) of the flexible board 2 and of the reinforcing plate 1 of the flexible board structure 3, has as a whole the appropriate level of stiffness•suppleness, through the combining of the stiffness•suppleness of the flexible board 2, and the stiffness•suppleness of the reinforcing plate 1. Moreover, the tip ends of the reinforcing plate 1 and the flexible board 2 as well as the both side ends are aligned respectively and are substantially flush.

As previously described, by firmly fixing the reinforcing plate 1 to the flexible board 2, the stiffness of the tip end 3a of the flexible structure 3 is increased, and thereby when the tip end 3a is inserted into the connector 4, even if insertion resistance for flexing the contact portion 40a of the terminal 40 is generated, this is overcome and [the flexible board 2] can be smoothly inserted. Also, in the tip end 3a of the flexible board structure 3, the electrical conductors 2f are exposed, so these electrical conductors 2f elastically contact the contact portion 40a of the terminal 40 of the connector 4.

As is clear from FIG. 20 and FIG. 21, a cutout portion 1p is provided in this reinforcing plate 1, which performs the role of the engaged portion 6. The cutout portion 1p is, for example, formed as an aperture by a stamping process when arranging the width L and the height H of the reinforcing plate 1 to correspond with the shape of the tip end of the board 2. This reinforcing plate 1 is pasted on one side surface 2b of the board 2 so as to cover the aperture of the cutout portion 1p. As a result, one side of the aperture of the cutout portion 1p is blocked by the board 2.

The locking member 50 has, as FIG. 16 to FIG. 19 show, a main body 52 arranged on a central portion of the upper surface of the housing 41 sectioning and forming the connector 4, a fitting portion 51 formed hanging down from the main body 52 and engaging with the fitting groove 47 formed in the housing 41, a hook 55 for engaging with a catching portion 48 formed in the housing 41, and an engaging portion 5 provided extending similar to an eave, in the [area] upwards position [from] the board insertion slot 43 of the connector 4 from the upper portion of the main body 52.

More specifically, the engaging portion 5 is provided extending like an eave in a direction facing the contact portion 40a of the terminal 40 of the connector 4 so as to block the operation of the tip end 3a of the flexible board structure 3 advancing into the board insertion slot 43 of the connector 4, and furthermore the two engaging portions 5 are formed spaced apart in the longitudinal direction of the insertion slots 43, such that when the tip end portion 3a is inserted in the connector 4, the cutout portion 1p of the reinforcing plate 1 is engaged in the engaging portion 5.

This locking member 50 is molded separately from the housing 41, and is firmly built on and integrated on the housing 41 by later on the hook 55 engaging with the catching portion 48 as well as the fitting portion 51 being inserted into the fitting groove 47. In this manner, the locking member 50 is configured separate from the housing 41, even if, as previously described, the engaging portion 5 is configured protruding like an eave in the [area] upwards [from] the board insertion slot 43 of the connector 4, a situation in which a forming die cannot be released does not occur when the housing 41 is molded.

Below, the effects of the present embodiment will be described.

When inserting the flexible board structure 3 in the connector 4, first grasp the flexible board structure 3 to function as an operation knob so as the electrical conductor 2f of the flexible board structure 3 faces the terminal contact portion 40a of the connector 4.

Next, insert the tip end 3a of the flexible board structure 3 into the board insertion space 44 from the board insertion slot 43 of the housing 41 of the connector 4. At this time, as the engaging portion 5 of the locking member 50 is extended in the [area] upwards [from] the board insertion slot 43, to avoid interference with this, it is necessary to insert the tip end 3a at a slight slant.

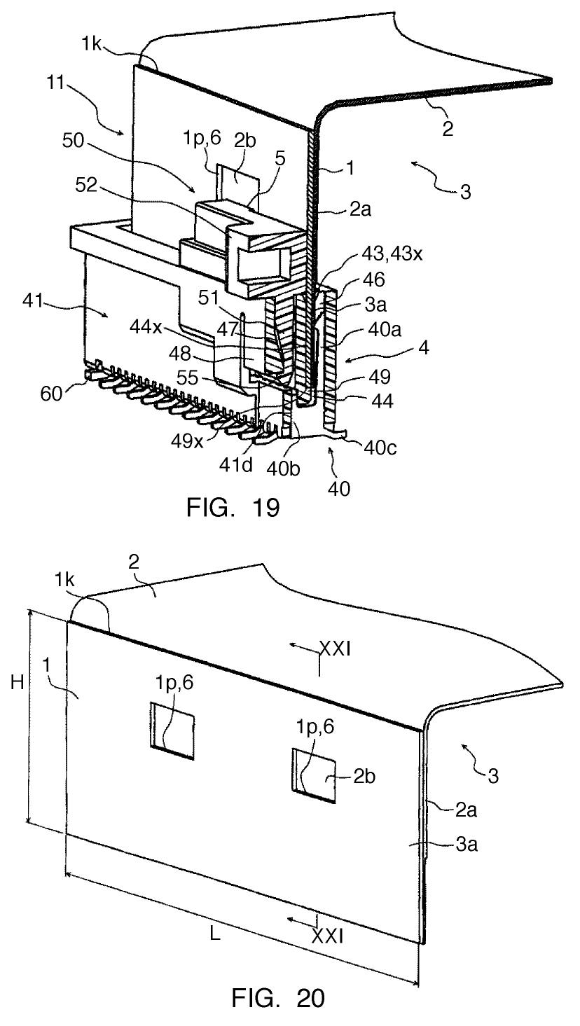

Observing this state in more detail, [it becomes clear] that the tip end 3a of the flexible board structure 3 can be inserted with substantially no resistance until the tip end of the rear surface (the surface of the side to which the board 2 is not adhered) of the reinforcing plate 1 [comes into contact with] the inner wall 44x (see FIG. 18 and FIG. 19) of the housing 41, the middle of the rear surface [comes into contact with] the engaging portion 5, and furthermore the inner surface (surface of the side on which the above described electrical conductor 2f is exposed) of the tip end 3a comes into contact with the guiding surface 43x formed at an angle in the board insertion slot 43 or in an R-shape, respectively.

The tip end 3a of the flexible board structure 3 is advanced [inward] from this state by increasing the insertion force, and while that tip end 3a maintains being in contact with the engaging portion 5 of the locking member 50 and the guiding surface 43x, the rear surface tip end of the reinforcing plate 1 slides down on the inner wall 44x of the housing 41. As a result, the tip end 3a of the flexible board structure 3 is supported at three points, [those being] a contact point with the engaging portion 5 of the locking member 50, a contact point with the guiding surface 43x, and a contact point with the inner wall 44x of the housing 41, and while bending bow-like, advances into the board insertion space 44.

At this time, before this, or after this, the above described inner surface of the tip end 3a of the flexible board structure 3 is advanced [inward] while abutting and elastically deforming the contact portion 40a of the terminal 40, and thereby in addition to the friction with the above described three points, it encounters a predetermined insertion resistance, however as the stiffness of the tip end 3a is increased by the reinforcing plate 1 and the flexible board 2 as previously described, this insertion operation can be carried out very smoothly.

The tip end 3a of the flexible board structure 3 is further advanced inward, at the moment or just before the tip end of the reinforcing plate 1 abuts the abutting portion 49, the cutout portion 1p serving as the engaged portion 6 and provided in the reinforcing plate 1 is fitted within the engaging portion 5 of the locking member 50, and the contact between the middle of the rear surface of the reinforcing plate 1 and the engaging portion 5 of the locking member 50 is released, and thereby the reinforcing plate 1 is restored by the elastic force thereof by the amount of the thickness of the cutout portion 1p to release the bow-like bending. As a result, the cutout portion 1p engages with the engaging portion 5 and the flexible board structure 3 is held in the connector 4.

When the cutout portion 1p is fitted within the engaging portion 5, through the restoration of the reinforcing plate 1 and the flexible board 2, [both of] which are curved and accumulated spring force, the one side surface 2b of the flexible board 2 blocking the cutout portion 1p collides with the tip end of the engaging portion 5 of the locking member 50, and/or a portion facing the locking member 50 of the reinforcing plate 1 collides with the locking member 50, and a “click” sound is generated as a collision sound, such that a feeling of insertion being completed can be obtained.

Please note, the previously described “‘click’ sound is generated” and “a feeling of insertion being completed can be obtained,” are not effects limited to the locking structure 11 according to the present embodiment disclosed in FIG. 16, but are effects which can be exhibited in the locking structure 11 according to the embodiments disclosed in FIG. 1, FIG. 6, FIG. 9, FIG. 10, FIG. 11 and FIG. 16 already described.

In a state in which insertion of the flexible board structure 3 into the connector 4 is completed, the tip end 3a of the flexible board structure 3 is pressed to the inner wall 44x side of the housing 41 by the spring force of the contact portion 40a of the terminal 40 of the connector 4, and thereby the cutout portion 1p configuring the engaged portion 6 is even more solidly engaged with the engaging portion 5, and unless a special external force is acted thereon, the tip end 3a of the flexible board structure 3 will not slip out from the connector 4.

On the other hand, when intentionally removing the flexible board structure 3 from the connector 4, by grasping a portion directly above the locking member 50, in other words, the laminated portion of the flexible board 2 and the reinforcing plate 1, and by bending this [in a manner] similar to laying it down onto the side opposite the locking member 50, the engagement between the cutout portion 1p configuring the engaged portion 6 and the engaging portion 5 is released, and then the [flexible board structure 3] can be gently pulled out by directly pulling upwardly at an angle.

In the present embodiment, in the flexible board structure 3, similar to the invention disclosed in Japan Patent Office published Unexamined Patent Publication No. H11-191326 described above, it is not necessary to provide a [component] such as a protruding portion on the side of the reinforcing plate, so there is no widening of the width of the board, or increase in the total width, in other words the occupied mounting area, of the connector. Also, as there is no need to provide a component such as the auxiliary member disclosed in Japan Patent Office published Unexamined Patent Publication No. H11-329621, a low cost locking structure can be configured.

This connector 4 is not a ZIF type comprising a movable member such as a turning member or a sliding member, and as it is not a connector which compromises any characteristics of a Non-ZIF type, it goes without saying that one action insertion of the board structure 3 is possible.

In the present embodiment, an example was described in which a butting portion 49 (FIG. 18, FIG. 19) was provided in the housing 41, however this role may be shifted to the terminal 40 of the connector 4.

Also, the engaging portion 5 of the locking member 50, was described as two components provided in the central portion of the long and narrow board insertion slot 43 extending in the longitudinal direction such as the drawing shows, however, [it may also be] provided each on both of the side ends of the board insertion slot 43, or one in the center.

Furthermore, the engaging portion 5, as already described, may also be formed as a surface slightly inclining downward toward the free end side thereof, or formed a slightly a protruding shape in a downward portion of the free end, to achieve improvement of the locking•latching properties of the reinforcing plate 1.

Moreover, it is simple to make the amount of protrusion (length of eaves) of the engaging portion 5 substantially corresponding to the thickness of the flexible board 2 and the reinforcing plate 1, however, depending on the thickness and stiffness of the reinforcing plate 1, or the height and such from the board insertion slot 43 of the engaging portion 5, it may be thicker or thinner than that, the bottom line being that the cutout portion 1p configuring the engaged portion 6 is locked in the above described engaging portion 5.

Please note, in FIG. 16 to FIG. 22, the flexible board 2 of the flexible board structure 3 is caused to bend in a substantially right angle direction in the proximity of the upper end 1k of the reinforcing plate 1, however this is simply [to] show an image in which another connector or such connected to the other end of the flexible board structure 2 exists in this direction, and including the bending has no special meaning whatsoever, and does not prevent the cutout portion 1p from extending substantially perpendicularly while locking with the engaging portion 5.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A locking structure of a flexible board which is inserted into and removed from a Non-ZIF type connector, comprising:
a flexible board structure formed by laminating a reinforcing plate onto one side surface of a tip end of said flexible board by positioning the reinforcing plate within the alignment region of the plurality of the electrical conductors composing said flexible board,
an engaged portion provided in said reinforcing plate of said flexible board structure by positioning at the medial of widthwise direction of the alignment region of the above described plurality of electrical conductors; and
an engaging portion provided in a board insertion slot of said connector, wherein
when the tip end of said flexible board structure is inserted into said board insertion slot, said engaged portion engages directly with said engaging portion through bending of said flexible board structure without shutting the above described flexible board in.

2. The locking structure of a flexible board according to claim 1, wherein said reinforcing plate has a fixed portion fixed to said flexible board, and a non-fixed portion not fixed to said flexible board, and
said engaged portion is provided in this non-fixed portion.

3. The locking structure of a flexible board according to claim 1, wherein said flexible board structure is formed by fixing the whole surface of said reinforcing plate to said flexible board, and
said engaged portion is formed from a step between an upper end of this reinforcing plate and said flexible board.

4. The locking structure of a flexible board according to claim 1, wherein said reinforcing plate has a cutout portion connecting the front surface and the rear surface thereof,
said cutout portion is blocked by said flexible board, and
said engaged portion is formed from said cutout portion.
